(19) United States
(12) Patent Application Publication
(10) Pub. No.: US 2011/0073637 A1
(43) Pub. Date: Mar. 31, 2011

(54) Reflow Air Management System and Method

(75) Inventors: Christopher Vincent, Avon, NY (US); Drew Knopfel, Fairport, NY (US)

(73) Assignee: SPX Corporation, Charlotte, NC (US)

(21) Appl. No.: 12/567,264

(22) Filed: Sep. 25, 2009

(51) Int. Cl. B23K 31/02; B23K 3/04

(52) U.S. Cl. 228/256; 228/19

(57) ABSTRACT

A reflow module of a reflow oven including a reflow fixture housed within a compartment of the reflow oven, removable side ports attached to the reflow fixture for controlling air flow through the reflow module and a chamber housing encasing the reflow fixture within the compartment of the reflow oven. A reflow oven incorporating the reflow module may include a reflow fixture having a plurality of air tubes and at least one orifice fixture plate removably attached to the reflow fixture, wherein the at least one orifice fixture plate includes a plurality of orifices for directing airflow into the plurality of air tubes.

### FIELD OF THE INVENTION

The present invention relates to a reflow air management system and related method, and more particularly, to a reflow oven having “quick change” side ports to toggle airflow paths to provide uniform temperature distribution to a semiconductor chip during reflow soldering.

### BACKGROUND OF THE INVENTION

Reflow soldering is a process in which a solder paste, made of powdered solder and flux, is used to temporarily hold components to attachment pads, after which the assembly is carefully heated in order to solder the joint. The assembly may be heated using an infrared lamp, or more commonly, by passing it through a carefully-controlled oven, or soldering with a hot air pencil. Reflow soldering is the most common method of attaching surface mount components, such as semiconductor chips, to a circuit board. Soldering forms a strong, long-lasting metallurgical bond between the surfaces being joined, both for structural integrity of the assembly and electrical conductivity of the electronic circuits.

The goal of the reflow process is to melt the solder alloy particles within the solder paste without overheating and damaging the electrical components. There are usually four stages of the reflow process, each having a distinct thermal profile, including: preheat, thermal soak, reflow and cooling. A conventional reflow oven may be used for reflow soldering of surface mount electronic components to printed circuit boards (PCBs). These ovens must maintain a particular reflow profile which fits within the specification or tolerance limit set by the user to ensure that the reflow soldering work does not overheat or cool too quickly. As semiconductors continue to decrease in product size, the real estate between each semiconductor is also decreasing to increase throughput.

Reflow is one of the hardest thermal processes to control with a high ramp up rate and a short pull down rate while maintaining uniformity of the specification for the end product. This problem of temperature profile uniformity has led many to develop several different reflow oven configurations. Most commonly, reflow ovens are large conveyor-type ovens that carry several moving parts. Conventional reflow ovens often include infrared/convection ovens.

Infrared ovens typically contain multiple heating zones, which can be individually controlled to maintain a desired temperature. These heating zones may be followed by one or more cooling zones. The printed circuit board moves through the oven on a conveyor belt, and is therefore subjected to a controlled time-temperature profile. In these ovens, the heat source is normally from ceramic infrared heaters, which transfer the heat to the assemblies by means of radiation. Infrared ovens which also use fans to force heated air towards the assemblies in combination with ceramic infra-red heaters are called infrared convection ovens.

Because these ovens have conveyors and other moving parts, these moving parts experience friction, which eventually injects metallic debris particles into the reflow path. During the thermal process, if the debris particles happens to land between these chips, there is a great potential to cause arcing or a short circuit. Currently, if one part breaks during the reflow cycle not only is the entire line shut down but the entire product in the oven at the time of shut down is suspect and usually rejected. Furthermore, these conventional ovens often include large housings which require a large amount of floor space to accommodate the conveyor belt configuration.

Accordingly, it is desirable to develop a reflow oven having minimal or no moving parts exposed in the batch configuration. It is also desired to provide a smaller oven housing, which will not require such a large space in a user facility.

### SUMMARY OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

The reflow air management system in accordance with the present invention overcomes many of the problems encountered in the conventional reflow ovens discussed above. Example embodiments of the invention include a reflow module of a reflow oven including a reflow fixture housed within a compartment of the reflow oven, removable side ports attached to the reflow fixture for controlling air flow through the reflow module and a chamber housing encasing the reflow fixture within the compartment of the reflow oven. In example embodiments, the removable side ports may include at least one slide plate slidably attached at an end of the reflow fixture. The reflow module may also include a performance pack providing the energy components to power the reflow oven, wherein the performance pack includes a cooling coil, a heater, a blower wheel and a motor. In other embodiments, the reflow module includes a boat carrier having a plurality of shelves attached to a generally L-shaped base.

Example embodiments of the present invention also include a reflow oven incorporating the reflow module. The reflow oven may include a reflow fixture having a plurality of air tubes and at least one slide plate slidably attached to the reflow fixture, wherein the at least one slide plate includes a plurality of orifices for directing airflow into the plurality of air tubes. In other embodiments the reflow oven may include: means for blowing an airstream along outside surfaces of a reflow fixture; means for directing the airstream through at least one outer plate and through a plurality of orifices within at least one slide plate; and means for further directing the airstream into a plurality of air tubes, wherein air flow through each of the plurality of air tubes may be separately controlled.

Alternate embodiments of the invention include a method of controlling airflow during a reflow stage, including: blowing an airstream along outside surfaces of a reflow fixture using a blower wheel; directing the airstream through at least one outer plate and through a plurality of orifices within at least one slide plate; and further directing the airstream into a plurality of air tubes, wherein air flow through each of the plurality of air tubes may be separately controlled. The method may also include directing the airstream through a plurality of tube openings along each of the plurality of air tubes and further directing the airstream through a plurality of bracket orifices and onto at least one semiconductor chip.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

### BRIEF DESCRIPTION OF THE DRAWINGS

FIG. 1 is a plan view illustrating a reflow oven incorporating a reflow air management system (RAMS) according to an embodiment of the invention.

FIG. 2 is an exploded view of a reflow module of the reflow oven shown in FIG. 1.

FIG. 3 is an exploded view of the RAMS of the reflow oven shown in FIG. 1.

FIG. 4A is an exploded view of a side of an air tube of the RAMS shown in FIG. 3.

FIG. 4B is a plan view of an underside of the air tube of FIG. 4A, without of its brackets.

FIG. 5 is a top view of the reflow oven shown in FIG. 1, showing the air flow path through the oven.

### DETAILED DESCRIPTION

Example embodiments of the present invention provide a reflow air management system (RAMS) which utilizes a direct airflow manifold to manage and control airflow during the reflow of semiconductor chips. Airflow can be changed using “quick-change” side ports to toggle airflow paths that provide uniform temperature distribution to the chip in a batch format. Because the RAMS is static and contains no moving parts, arcing or short circuits are less likely to occur. Some embodiments will now be described with reference to the drawing figures, in which like reference numbers refer to like parts throughout.

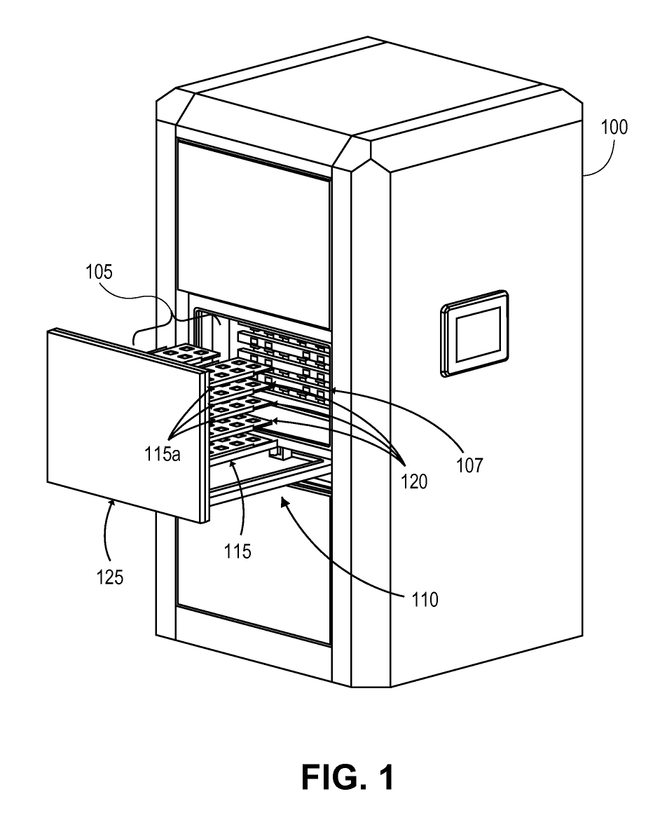

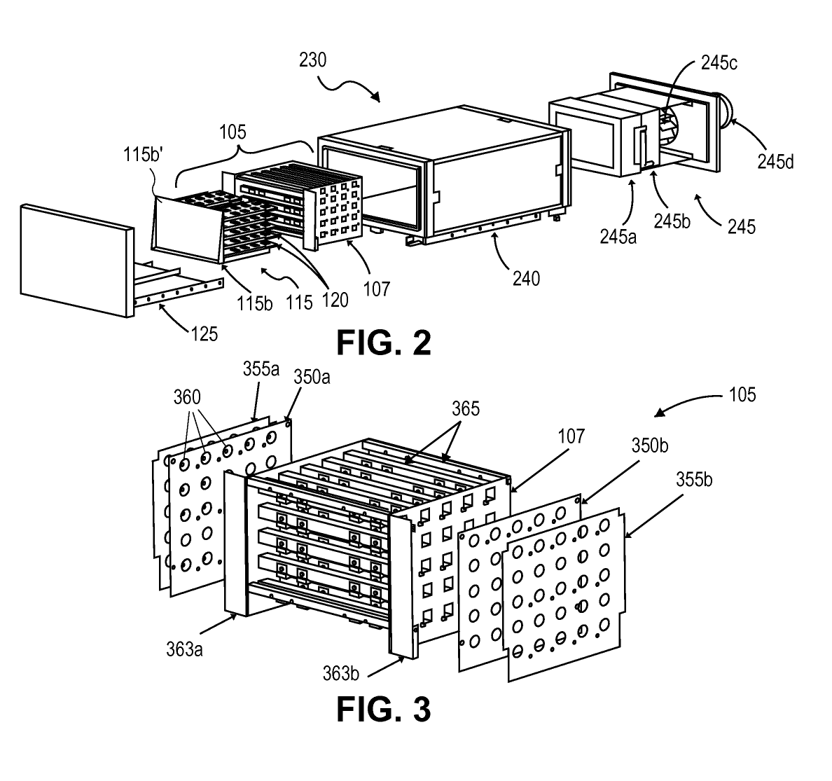

FIG. 1 is a plan view illustrating a reflow oven 100 incorporating a RAMS 105 according to an embodiment of the invention. In this embodiment, the RAMS 105 includes a reflow fixture 107, which is housed within a compartment or drawer 110 of the reflow oven 100. In example embodiments, the drawer 110 may be approximately 1-3 feet deep to accommodate the RAMS 105. In example embodiments of the invention, the RAMS 105 also includes a boat carrier 115, which may include shelves 115a attached to a generally L-shaped carrier base 115b including a backplate 115b′ (as best shown in FIG. 2) to accommodate rows of semiconductor boats 120, is fixed to a door 125 of the drawer 110. In example embodiments the boats 120 may hold central processing unit chips, personal computer boards or any other electronics.

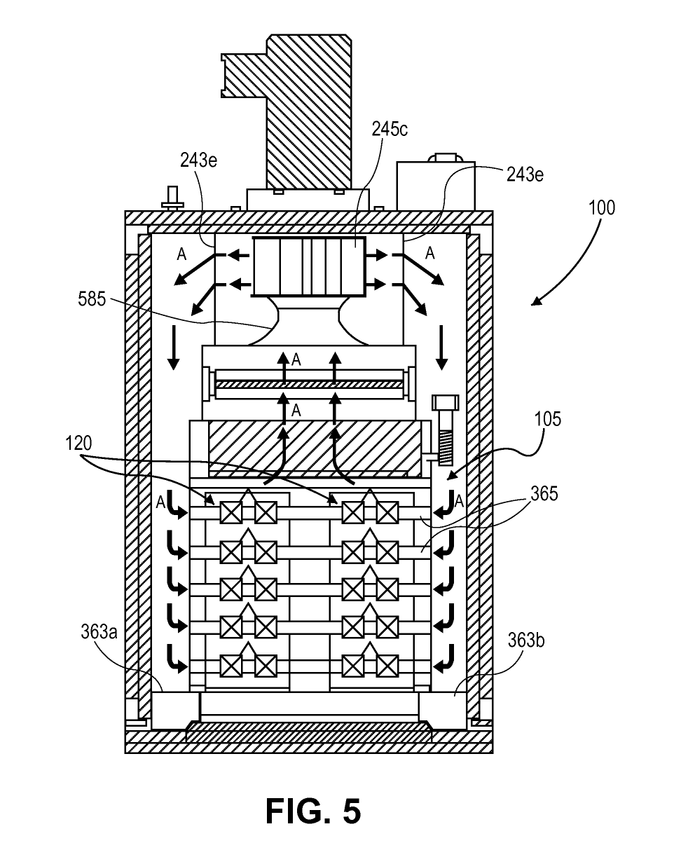

FIG. 2 is an exploded view of a reflow module 230 of the reflow oven 100 shown in FIG. 1. In example embodiments of the invention, the reflow module 230 includes: the drawer door 125, the boat carrier 115, the reflow fixture 107, a chamber housing 240 and a performance pack 245. In example embodiments of the invention, the performance pack 245 includes the energy components needed to drive the reflow oven 100 specifically including: a cooling coil 245a to provide cool air during the controlled cooling stage of reflow, a heater 245b to provide hot air during the rapid heating stage of reflow, a blower wheel 245c to drive air flow, a motor 245d to provide power to the performance pack 245 and air deflectors 245e (shown in FIG. 5) to direct air flow towards the RAMS 105. In example embodiments, the cooling coil 245a may be stainless steel and the heater 245b may be a resistive heater. The reflow fixture 107 may be specially designed for a particular reflow stage or alternatively, may be removed for non-reflow stages.

FIG. 3 is an exploded view of the RAMS 105 of the reflow oven 100 shown in FIG. 1 (without the carrier backplate 115b′). In example embodiments of the invention, the reflow fixture 107 is bookended by a pair of slide plates 350a, 350b and outer plates 355a, 355b. The slide plates 350a, 350b provides variously sized orifices 360 to control airflow and thereby, provide the appropriate reflow profile for a particular system. The slide plates 350a, 350b may be slidably removable plates which can be changed for each user system. In example embodiments, the outer plates 355a, 355b are also slidably attached. The RAMS 105 may also include air deflectors 363a, 363b to prevent air from flowing around the sides of the RAMS 105. In example embodiments of the invention, air is directed through each air tube 365 of the RAMS 105.

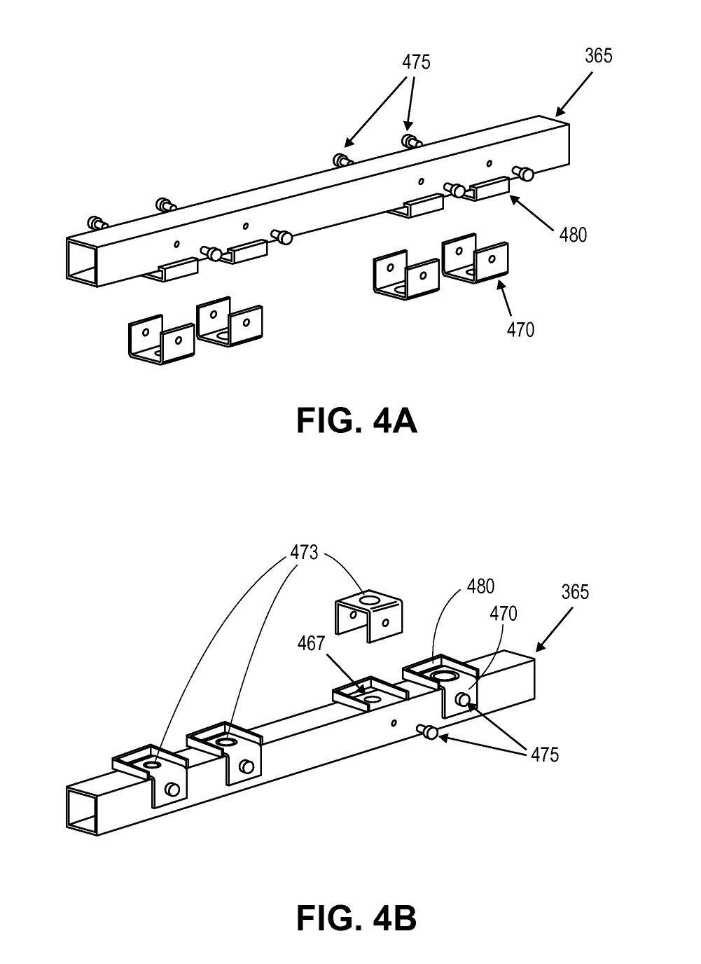

FIGS. 4A and 4B provide alternate views of an air tube of the RAMS shown in FIG. 3. In example embodiments, the air tube may be shaped like a cylinder, prism or any other tube shape. The RAMS 105 may include a plurality of air tubes 365, each having a plurality of openings 467 along the underside of each tube 365 to direct airflow to each individual semiconductor chip on the semiconductor boats 120. In these embodiments, a u-shaped bracket 470 is attached to each opening of each of the tubes 365 using screws 475. In some embodiments of the invention, there are 4 brackets 470 per tube 365. The brackets 470 may additionally include variously sized bracket orifices 473 to further control air flow. In some embodiments of the invention, air flow shields 480 may be used to prevent each chip from receiving airflow from a neighboring chip.

FIG. 5 is a top view of the reflow oven shown in FIG. 1, showing the air flow path A through the oven 100. In a method of controlling airflow during a reflow stage, the blower wheel 245c sends cool or hot air, depending on which phase of reflow is occurring, along the outsides of the RAMS 105. In example embodiments of the invention, the air can be an inert gas such, as argon, nitrogen, or other inert gases. In example embodiments of the invention, the air flow A is directed through the pair of outer plates 355a, 355b and through the orifices 360 of the slide plates 350a, 350b and into each air tube 365 of the RAMS 105. Air flow through each air tube 365 may be separately controlled. The air path continues through air tubes 365 and into each of the plurality of tube openings 467 and through each bracket orifice 473 and onto each semiconductor chip on the boats 120.

Several features of the invention help to direct the airflow path A, thereby ensuring uniformity of the reflow profile. Air deflectors 363a, 363b prevent air flow from flowing around the RAMS 105. Another set of air deflectors 245e help direct air flow towards and into the RAMS 105. In some embodiments of the invention, the performance pack 245 may also include a Venturi cone 585 to improve the venturi effect of the airflow into the blower wheel 245c. As mentioned above, the air flow shields 480 (shown in FIG. 4) may be used to prevent each chip from receiving airflow from a neighboring chip.

The many advantages of the reflow oven 100 of the present invention would be readily understood by one of ordinary skill in the art. The unique change plates 350a, 350b controlling air flow into the RAMS 105 provide versatility of the system such that the system may be tuned without changing the air tubes. Furthermore, the orifices 360, which may have build-up that potentially alters the desired air profile, may be cleared off when the plates 350a, 350b are removed. Example embodiments of the reflow oven 100 of this invention also substantially reduce the problems with existing reflow conveyor ovens that substantially decrease available floor space. In addition, the modular and unique jet flow design, offers the end user the flexibility to alter product lines without significant interruption. Because of the sealed environment and static processing, there are no moving parts or particulate contamination issues incurred within the reflow oven 100. Many different recipes and product configurations can be tested simultaneously because airflow can be controlled for each individual air tube 365.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A reflow module of a reflow oven, comprising:
a reflow fixture housed within a compartment of the reflow oven;
removable side ports comprising a plurality of orifices attached to an end of the reflow fixture for controlling air flow through the reflow module;
and a chamber housing encasing the reflow fixture within the compartment of the reflow oven.

2. The reflow module of claim 1, further comprising a boat carrier having a plurality of shelves attached to a generally L-shaped base.

3. The reflow module of claim 1, wherein the compartment is a drawer closing off the compartment of the reflow oven.

4. The reflow module of claim 1, further comprising a performance pack providing the energy components to power the reflow oven, wherein the performance pack includes a cooling coil, a heater, a blower wheel and a motor.

5. The reflow module of claim 4, wherein the performance pack further includes air deflectors.

6. A reflow module of a reflow oven, comprising:
a reflow fixture housed within a compartment of the reflow oven;
removable side ports attached to the reflow fixture for controlling air flow through the reflow module;
and a chamber housing encasing the reflow fixture within the compartment of the reflow oven,
wherein the removable side ports include at least one orifice fixture plate removably attached at an end of the reflow fixture.

7. The reflow module of claim 6, wherein the at least one orifice fixture plate has a plurality of orifices.

8. The reflow module of claim 7, wherein the plurality of orifices are variously sized.

9. The reflow module of claim 6, wherein the at least one orifice fixture plate includes a pair of slide plates which bookend the reflow fixture.

10. The reflow module of claim 6, further comprising at least one outer plate attached to the reflow fixture, outside of the at least one orifice fixture plate.

11. The reflow module of claim 1, further comprising air deflectors attached to the reflow fixture.

12. The reflow module of claim 1, further comprising a plurality of air tubes within the reflow fixture.

13. The reflow module of claim 12, further comprising a plurality of openings along an underside of each air tube.

14. The reflow module of claim 13 further comprising a U-shaped bracket attached to each of the plurality of openings.

15. The reflow module of claim 14 further comprising a bracket orifice within each U-shaped bracket.

16. The reflow module of claim 12, wherein each air tube is shaped like a prism.

17. The reflow module of claim 13, wherein each air tube opening includes an air flow shield.

18. The reflow module of claim 4, wherein the performance pack comprises a Venturi cone.

19. A reflow oven, comprising:
a reflow fixture having a plurality of air tubes; and
at least one orifice fixture plate removably attached to an end of the reflow fixture, wherein the at least one orifice fixture plate includes a plurality of orifices for directing airflow into the plurality of air tubes.

20. A method of controlling airflow during a reflow stage, comprising:
blowing an airstream along outside surfaces of a reflow fixture using a blower wheel;
directing the airstream through at least one outer plate and through a plurality of orifices within at least one slide plate; and,
further directing the airstream into a plurality of air tubes, wherein air flow through each of the plurality of air tubes may be separately controlled.

21. The method of controlling airflow of claim 20, further comprising directing the airstream through a plurality of tube openings along each of the plurality of air tubes.

22. The method of controlling airflow of claim 21, further comprising directing the airstream through a plurality of bracket orifices and onto at least one semiconductor chip.

23. A reflow oven, comprising:
means for blowing an airstream along outside surfaces of a reflow fixture;
means for directing the airstream through at least one outer plate and through a plurality of orifices within at least one orifice fixture plate attached at an end of the reflow fixture; and,
means for further directing the airstream into a plurality of air tubes, wherein air flow through each of the plurality of air tubes are configured to enable air flow through each air tube to be separately controlled.
